(19) United States
(12) Patent Application Publication
(10) Pub. No.: US 2003/0131480 A1
(43) Pub. Date: Jul. 17, 2003

(54) Hair clipper with turbo-cutting mode

(75) Inventors: Kit Lun Leung, Hong Kong (CN); Mo Hung Pau, Hong Kong (CN)

Correspondence Address: Charles N.J. Ruggiero, Esq., Ohlandt, Greeley, Ruggiero & Perle, L.L.P., 10th Floor, One Landmark Square, Stamford, CT, 06901-2682, US

(73) Assignee: CONAIR CORPORATION

(21) Appl. No.: 10/340,217

(22) Filed: Jan. 10, 2003

Related U.S. Application Data
(60) Provisional application No. 60/347,278, filed on Jan. 11, 2002.

(51) Int. Cl. B26B 19/02; B26B 19/12

(52) U.S. Cl. 30/210

(57) ABSTRACT

A hair clipper having a bypass switch is provided. The clipper has a clipper head having a first blade and a reciprocating second blade to form a cutting edge. The clipper also has an interior for housing a drive mechanism that drives the reciprocating second blade and a power supply. The power supply is operatively connected to the drive mechanism and a switch having an on position corresponding to an operating condition, an off position corresponding to a non operating position, and a third position. When the switch is in the third position, the drive mechanism drives the reciprocating blade at a speed above the normal operating condition.

### CROSS REFERENCE TO A RELATED APPLICATION

This application claims priority and the benefit of U.S. Provisional Application No. 60/347,278, filed on Jan. 11, 2002.

### BACKGROUND OF THE INVENTION

1. Field of the Invention

The present invention relates to a hair clipper. More particularly, the present invention relates to a hair clipper having a turbo-cutting or increased speed cutting mode.

2. Description of the Prior Art

Electric hair clippers having an on-off switch and high/low switches are known in the art. Generally, prior art electric hair clippers have a housing with a gripping section for a handle. The handle houses a motor and a power supply that is electrically connected to an on-off switch. The switch itself or the handle also has a high and a low cutting speed switch. When a user engages the on-off switch, the motor will rotate usually an eccentric cam. The eccentric cam will rotate a toothed blade assembly. In this manner, the blade assembly provides for mechanical cutting action to trim hairs positioned between the teeth of the blade assembly.

Given the irregularity of a trimming surface and thickness variations of the hair, it is desirable for the user not only to manipulate the angle of the clipper, but also for the user to intermittently increase the speed of the motor to better control and vary the speed of the blade assembly. On-off switches and high and low switches may be positioned on one slidable switch or two separate switches. Since the engagement of the high and low switches results in a momentary interruption of the trimming to change the speed of the blade assembly, complicated and inconvenient operation of the clipper results. Also, there is a decrease in the trimming action of the clipper since a user must facilitate adjustment of the high and low switches to increase or to vary the speed of the motor, and then the rotation of the blade assembly.

Thus, it is desirable to provide a hair trimmer that permits simple adjustment of the speed of the blade assembly to better enable the user to, without interruption, more precisely and productively trim the desired hair and achieve a more skillful and productive trimming.

### SUMMARY OF THE INVENTION

It is an object of the present invention to provide a clipper having a switch that is capable of adjusting the cutting speed of the blade assembly by a simple manipulation of a single switch.

It is another object of the present invention to provide a clipper having a switch that is capable of adjusting the cutting speed of the motor and blade assembly to the maximum possible speed, by a simple manipulation of the switch.

It is yet another object of the present invention to provide a clipper having a switch that is capable of increasing the cutting speed of the blade assembly without interruption of any cutting or trimming.

The present invention includes a clipper having a bypass switch, a blade assembly, a motor, an output shaft and a power supply, and a structure for reciprocating the blade assembly. The bypass switch has an opened position and a closed position, and is electrically connected to a current regulating element that reduces the current from the power supply to the motor.

When a user desires to increase the clipping speed of the blade assembly, the user actuates or moves the bypass switch from the open position to the closed position. In the closed position, power no longer passes through the current regulating element, and instead passes across the bypass switch to the motor thereby increasing the power to the motor. In this manner, the motor with increased power intensifies the rate of speed that translates into an increase of reciprocation of the blade assembly thereby resulting in increased speed or mechanical cutting action.

The above and other objects, advantages and benefits of the present invention will be understood by reference to the detailed description provided below and the accompanying drawings.

### DESCRIPTION OF THE DRAWINGS

FIG. 1 is a perspective view of a hair clipper of the present invention;

FIG. 2, is a partial cross-sectioned view of the hair clipper of FIG. 1;

FIG. 3 is a diagram of the exemplary circuit of the switch of the hair clipper of FIG. 1;

FIG. 4 is a diagram of the PCB sketch of the hair clipper of FIG. 1; and

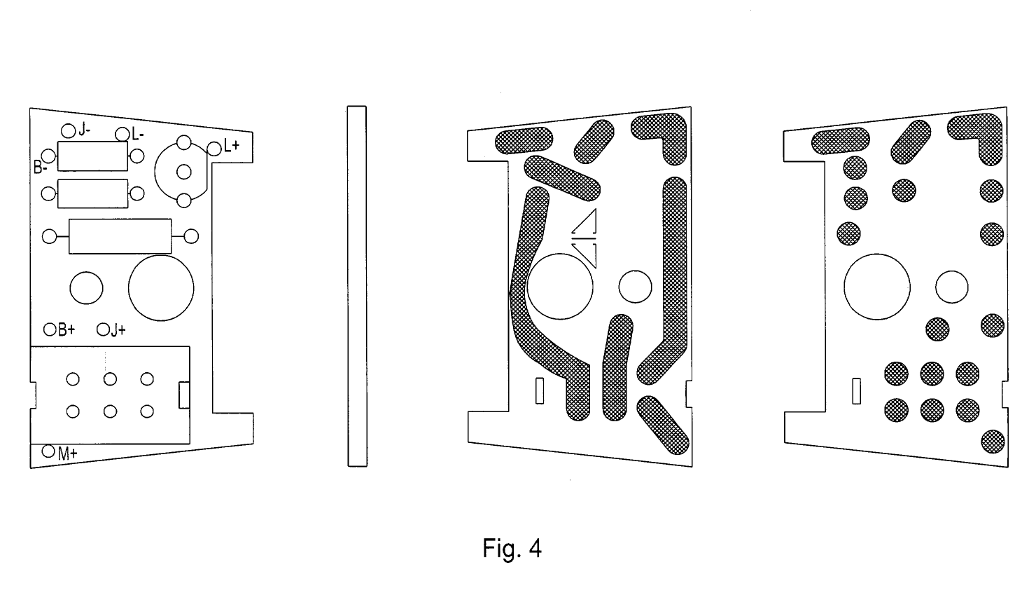

FIG. 5 is a diagram of the PCB contact plate of the hair clipper of FIG. 1.

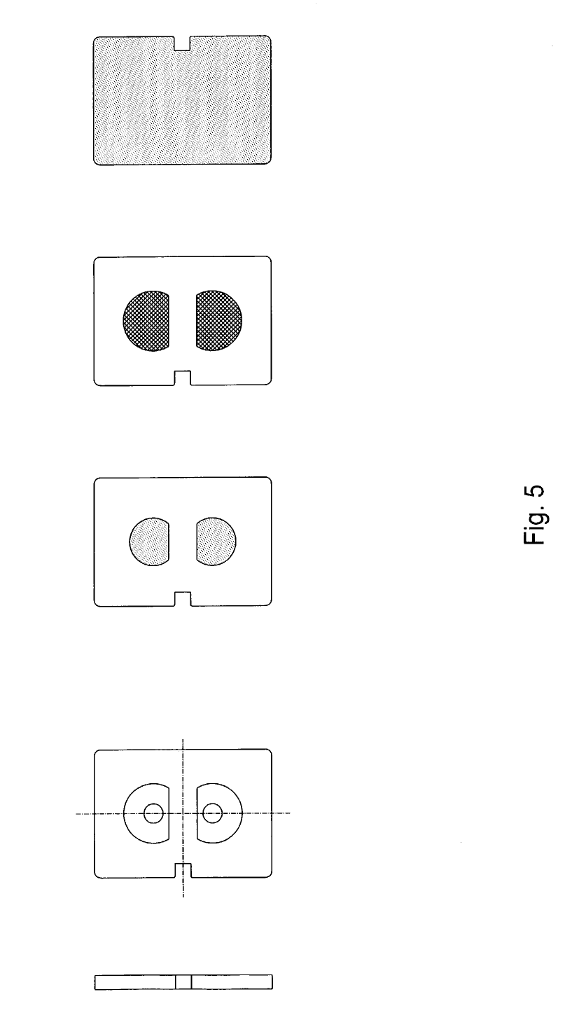

### DETAILED DESCRIPTION OF THE INVENTION

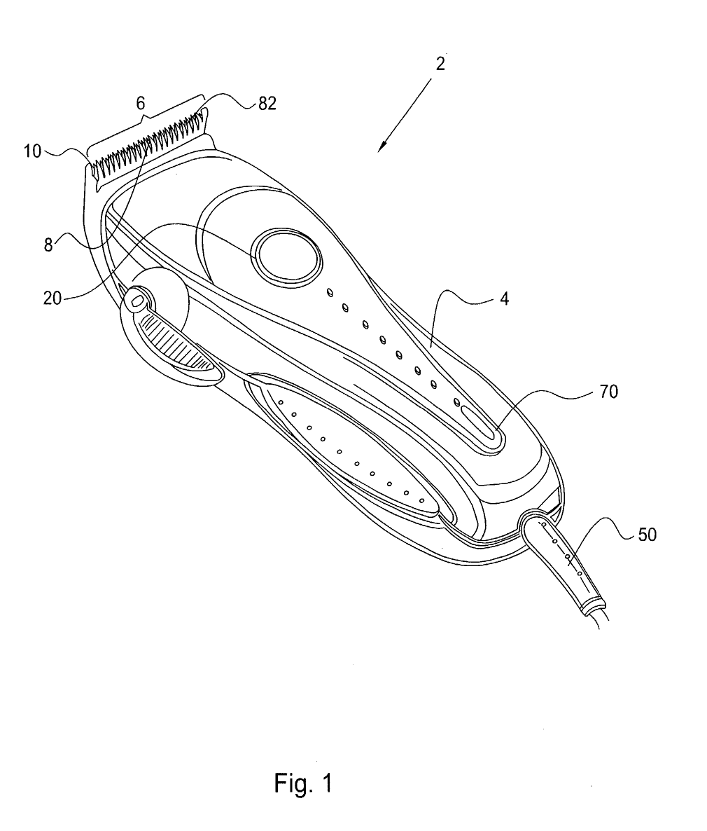

Referring to the drawings and in particular FIG. 1, there is provided a hair clipper generally represented by reference numeral 2. The clipper 2 has a housing 4, a blade assembly 6 that can be removably connected to the housing, and a bypass switch 20 positioned in/on the housing 4. The clipper 2 preferably has a power cord 50 adapted to be operatively connected to the housing 4.

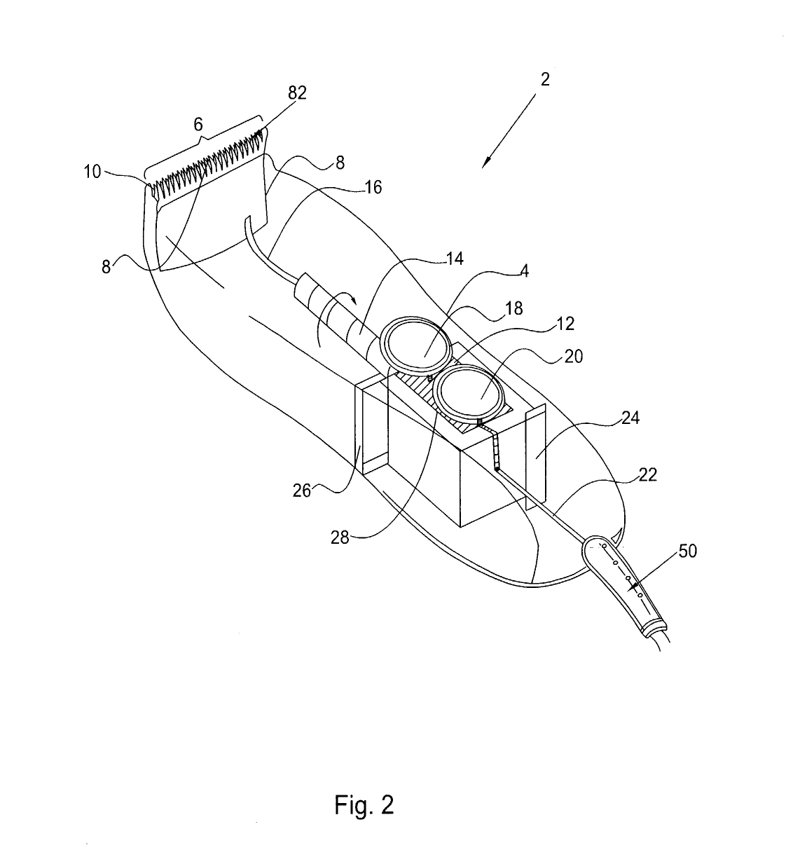

Referring to FIGS. 1 and 2, the housing 4 may be made of any thermoplastic material or any other solid material. Also, the housing 4 may be shaped into an elongated configuration with a longitudinal axis or any other desired aesthetic configuration.

The blade assembly 6 may be a reciprocating blade assembly, a rotary blade assembly or any other blade assembly known in the art for accomplishing cutting or trimming of hair. The blade assembly 6 preferably has a movable reciprocating blade 8 in slidable contact with a stationary blade 10 to define a cutting plane exposed at a front end of the housing 4 opposite the power cord 50. The reciprocating blade 8 and the stationary blade 10 may have teeth, or instead could have a razor edge or any other acceptable cutter or cutting means to cut the hair positioned between the reciprocating blade 8 and the stationary blade 10. Further, the present invention may be adapted to satisfy other embodiments of clippers having for example a rotary blade assembly, an edged unit blade assembly, a taper unit assembly or any other blade assemblies for clipping or trimming hair known in the art.

Both stationary blade 10 and reciprocating blade 8 preferably have a number of teeth 82. The teeth 82 are positioned along a leading edge of the blade assembly 6. In another embodiment of the present invention, the stationary blade 10 of the blade assembly 6 may be connected to the housing 4 such that the teeth 82 form a cutting edge that is offset from the housing 4. Accordingly, the user's hair that is placed within the teeth 82 is trimmed as the reciprocating blade 8 reciprocates with regard to the stationary blade 10.

Referring to FIG. 2, the housing 4 has an interior that is sized for housing a motor 12 and an output shaft 14. The output shaft 14 is connected between the motor 12 and a drive member 16. The drive member 16 extends from the output shaft 14 to the reciprocating blade 8. Activation of the motor 12 causes rotation of the output shaft 14 and movement of the drive member 16 so that the reciprocating blade 8 reciprocates back and forth preferably substantially perpendicular to a longitudinal axis of the housing 4. It should be appreciated by one skilled in the art that a cam (not shown) or other means known for translating the rotation of the motor 12 to the reciprocating motion of the reciprocating blade 8 can be used and is within the scope of the present invention.

The housing 4 also has an outer surface or body well for receiving or mounting a power switch 18 and the bypass switch 20. The power switch 18 may be any power switch that provides power to the clipper 2. Preferably, the power switch 18 is a three-position on/off switch operatively connected to the motor 12. In one preferred embodiment, the power switch 18 is also operatively connected to one or more rechargeable batteries (not shown). The three-position on/off switch has a first position, a second position, and a third position. In a first switch position, the motor 12 is in an operating or on condition. In a second switch position, the rechargeable batteries (not shown) are charging or in a preferred embodiment it overrides a conventional power supply 22 and operates the clipper 2. In a third switch position, the motor 12 is in a non-operating or off condition.

The power switch 18 and the bypass switch 20 are operatively connected to the motor 12 and the power supply 22 preferably by a printed circuit board 28. The printed circuit board 28 is connected to, and preferably mounted on, the motor 12 or motor casing, or in a suitable location in the interior of the housing 4 so as to be electrically connected to the power supply 22. Preferably, the housing 4 also has one or more notches 24, 26 that hold the motor 12 in place in the housing.

The motor 12 may be a DC motor or any other suitable drive mechanism that is capable of a number of different fixed speeds. Preferably, the motor 12 has high, medium and low operating speeds or modes and also operates at the intensified condition, e.g., at a maximum speed of the motor. A line voltage of the power source and a volts/rpm rating of the motor 12 preferably set this maximum speed. In a preferred embodiment, the motor 12 preferably has about a 6-volt rating.

Alternatively, motor 12 can have any number adjustable speeds, including but not limited to, n, n+1, n+2, n+3. Here, the intensified condition may the next sequential higher speed of operation of the motor 12.

In another, but less preferred, embodiment of the present invention, the motor 12 may preferably have at least two speeds, a high speed and a low speed. In this alternative embodiment, the intensified condition may be merely the high speed.

In an alternative embodiment, the interior of housing 4 has one or more air flow openings (not shown) and a fan assembly (not shown). The fan assembly (not shown) is operatively connected to the power supply 22. [PLEASE PROVIDE A NEW FIG. 2 THAT SHOWS FAN]. The fan assembly causes air to flow into and out of the one or more air flow openings for cooling the motor 12 and the components of the clipper 2. The power supply 22 may be any household electrical current source, a 120 volt 50 to 60 Hz source connected by a suitable plug 50 as shown in FIG. 1, a battery 60 or any combinations thereof.

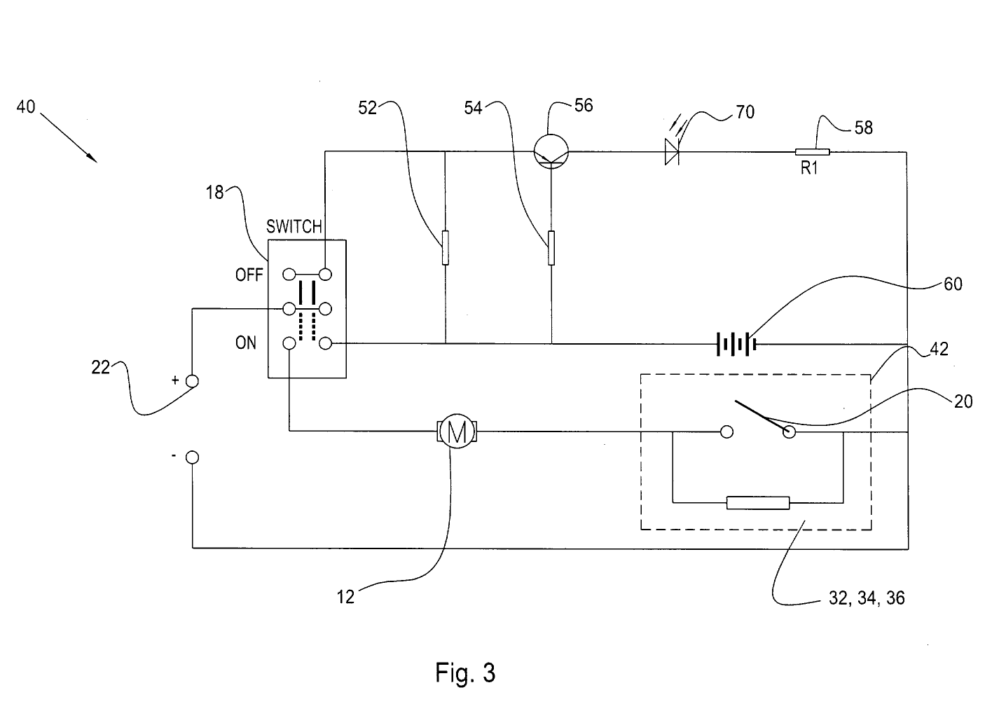

Referring to FIG. 3, an exemplary circuit 40 is provided. The circuit 40 is preferably positioned on the printed circuit board 28. The circuit 40 preferably has the power supply 22 that applies current through the power switch 18 across the motor 12 that is serially connected to a bypass switch assembly 42. The bypass switch assembly 42 includes the bypass switch 20 and a current regulating element 32. The bypass switch assembly 42 regulates the current or power supplied from the power supply 22 to the motor 12 based on the actuation of the bypass switch 20.

The power supply 22 is preferably operatively connected to power switch 18 and the bypass switch assembly 42. The power supply 22 preferably is suitable to operate the motor 12 and the blade assembly 6 and, in an alternative embodiment, to charge a battery 70. In this alternative embodiment, three 1.2-volt rechargeable batteries are used. However, any acceptable battery or number of batteries of suitable power for cordless operation of the motor 12 and the blade assembly 6 may be used to operate the clipper 2.

The bypass switch 20 has an open position and a closed position, and is electrically coupled or connected to a current element 32. The current element 32 is connected to a return path of the power supply 22 and the motor 12. Preferably, the bypass switch 20 is connected in the bypass switch assembly 42 to the current element 32. The bypass switch 20 can be easily switched to the open or the closed position preferably with a mere application of a force applied by the user to the bypass switch.

In a preferred embodiment, the bypass switch 20, and thus the circuit 40, provides the user with the option of driving the motor 12 at the intensified condition when the user actuates the bypass switch from the open position to the closed position. The intensified condition means that more current is provided to the motor 12 than of any one of the normal operating conditions so that a greater than normal speed of operation of the motor occurs. The motor 12 operating at the increased current reciprocates the blade assembly 6 at a greater speed than all normal operating conditions. The bypass switch 20 enables the user to easily achieve an increase of the speed of reciprocation of the reciprocating blade 8, thereby achieving an increase of the mechanical cutting force for a more efficient and productive trimming. Thus, when the user desires an increased rate of reciprocation of the blade assembly 6, preferably to trim thick hairs or due to an irregular trimming surface, the user simply actuates the bypass switch 20 from the open position to the closed position.

The current element 32 may be for example a diode 34, a metal oxide resistor 36, a capacitor (not shown), a fuse (not shown), two or more resistors coupled in series, two more resistors coupled in parallel, or a bridge rectifier circuit or any other suitable device.

In another embodiment of the clipper 2, the intensified condition may be the current rate of operation of the motor 12 plus an increase in speed based upon a fixed percentage of the current rate of operation. For example, the intensified condition may be the current rate of operation plus, for example, a portion such as ten percent of the current rate of operation.

In operation, when the user places the power switch 18 of clipper 2 in the first position, current flows from the power supply 22 through the bypass switch assembly 42 to the motor 12 when the bypass switch 20 is in the open position. The blade assembly 6 operates for normal use. When bypass switch 20 is in the closed position, current from the power supply 22 moves through the bypass switch 20 to the motor 12. This increases the current ordinarily delivered to the motor 12 relative to the operating condition.

When the user is satisfied with the intensified mechanical cutting action of the blade assembly 6 of the clipper 2 and desires to return to the normal operating speed of the clipper 2, the bypass switch 20 is opened. In this manner, current is no longer applied through the bypass switch 20 and is applied through the current element 32. Thus, the speed of the blade assembly 6 is reduced to a normal operating speed. One skilled in the art should appreciate that in another preferred embodiment, a switch assembly may include bypass assembly 42 and power switch 18 as one discrete switch.

The bypass switch 20 may be a two-position on/off switch, or even possibly a three-position on/off switch. Alternatively, the bypass switch 20 may be an axially movable switch-operating member, a rotary adjusting dial or any other switch member known in the art.

In one aspect, the bypass switch 20 may be on the exterior of the housing 4. The bypass switch 20 may be placed on the opposite side of the housing 4 relative to the power switch 18, on a lateral side of the housing 4, or on a top of the blade assembly 6 opposite the power cord 50. Alternatively, the bypass switch 20 may be located adjacent to the power switch 18 on the housing 4 or as another position on the power switch 18, for example a fourth position on the power switch 18.

In another preferred embodiment of the present invention where clipper 2 has the battery 60, the battery is operatively connected to the power supply 22 and a recharge indicator 70. The power supply 22 applies current in the second position through the power switch 18 to recharge the battery 60 and to operate the recharge indicator 70.

In an alternative embodiment, the circuit 40 may have the recharge indicator 70 connected between the power switch 18 and the battery 60, or any other location in the circuit. The recharge indicator 70 may be any instrument used to monitor the operation or condition of one or more components of the clipper 2. The recharge indicator 70 alternatively may be used to monitor the operation of the battery 60. The recharge indicator 70 may have a first state when the battery 60 is recharging, and a second state when the battery is fully recharged.

In the embodiment shown in FIG. 3, the recharge indicator 70 is a light emitting diode or LED 70. The LED 70 has a first on or illuminated state and a second darkened off state. In use, the LED 70 is illuminated when the battery 60 is charging, and the LED 70 is dark when the battery 60 is fully charged. The LED 70 may also be used to indicate whether the motor 12 is either in the on mode, off mode or in the intensified condition.

When the clipper 2 is not in operation and the power switch 18 is in the second position, the power supply 22 is operatively connected to the power switch 18 and the resistor 52. The resistor 52 is connected to a resistor 54 and a transistor 56. The transistor 56 is connected to the recharge indicator 70 and the resistor 58. In operation, current from the power supply 22 is applied across the power switch 18, the resistors 52, 54, and 58, and the transistor 56 to amplify the current to operate the recharge indicator 70 and/or charge the battery 60.

Other modifications of the present invention will be obvious to those skilled in the art in the foregoing teachings. Moreover, while the present invention has been described with reference to specific embodiments and particular details thereof, it is not intended that these details be construed as limiting the scope of the invention, which is defined by the following claims.

What is claimed is:

1. A hair clipper comprising:
a body;
a clipper head adapted to be connected to said body, said clipper head having a cutting assembly;
a drive mechanism for operatively driving a portion of said cutting assembly when said cutting assembly is connected to said body;
a power supply being operatively connected to said drive mechanism; and
a switch system being positioned on said body, said switch system having a switch with a first position in which said clipper assembly operates, a second position and a third position,
wherein said drive mechanism drives said portion of said cutting assembly at a speed greater than said operating condition when said switch is in said third position.

2. The hair clipper of claim 1, wherein said speed is substantially equal to a maximum drive speed of said drive mechanism.

3. The hair clipper of claim 1, wherein said switch system includes a switch assembly.

4. The hair clipper of claim 3, wherein said switch assembly has a switch and a current regulating element.

5. The hair clipper of claim 4, wherein said current regulating element is selected from the group consisting of a diode, a resistor, a capacitor, a fuse, two or more resistors connected in series, two more resistors connected in parallel, a bridge rectifier circuit, and any combinations thereof.

6. The hair clipper of claim 1, wherein said switch is operatively connected to a bypass circuit for regulating current to said drive mechanism.

7. The hair clipper of claim 1, wherein said third position of said switch provides an increased current for driving said portion of said cutting assembly.

8. The hair clipper of claim 1, wherein said switch system includes a bypass circuit that has a current regulating element.

9. The hair clipper of claim 6, wherein said bypass circuit is electrically connected to said power supply and said drive mechanism for regulating said current to said drive mechanism.

10. The hair clipper of claim 1, wherein said switch is a tri-state switch.

11. The hair clipper of claim 1, further comprising a rechargeable battery operatively connected to said power supply for operating said drive mechanism.

12. The hair clipper of claim 1, wherein said operating condition is about half a drive speed of said drive mechanism.

13. The hair clipper of claim 1, further comprising a second switch for actuating said cutting assembly from said operating condition to a level of operation selected from the group consisting of a maximum speed of reciprocation, a portion of said maximum speed of reciprocation, said operating condition plus a function of said operating condition, one or more adjustable speeds of reciprocation, and any combinations thereof.

14. The hair clipper of claim 1, wherein said switch system has a second switch connected between said drive mechanism and said power supply.

15. The hair clipper of claim 14, wherein said second switch is an on/off switch.

16. The hair clipper of claim 1, further comprising an indicator responsive to said third position.

17. The hair clipper of claim 16, wherein said indicator is at a location selected from the group consisting of said body, said switch, a second switch, and any combinations thereof.

18. The hair clipper of claim 16, wherein said indicator is selected from the group consisting of a light emitting diode, an alarm, an audible signal, and any combinations thereof.

19. The hair clipper of claim 1, wherein said power supply is selected from the group consisting of a rechargeable power supply, a rechargeable battery, a DC power source, and any combinations thereof.

20. A hair clipper system comprising:
a blade assembly;
a housing for holding a motor therein and a drive mechanism connected to said motor, said drive mechanism for reciprocating said blade assembly;
a power cord operatively connected to said motor, and adapted for connection to a standard household electrical outlet; and
a three-position on/off switch being connected to said drive mechanism, said switch having a first switch position at which said drive mechanism operates at a first, normal operation state, a second switch position at which said drive mechanism does not operate, and a third switch position at which said drive mechanism is operating at a second state, wherein said second state has a higher rate of reciprocation of said blade assembly than said first state.

21. The hair clipper of claim 20, further comprising a second switch having a first switch position and a second switch position at which said drive mechanism is operating at said second state.
